(19) United States
(12) Patent Application Publication
(10) Pub. No.: US 2024/0311202 A1
(43) Pub. Date: Sep. 19, 2024

(54) MULTI-RUNTIME WORKLOAD FRAMEWORK

(71) Applicant: Red Hat, Inc., Raleigh, NC (US)

(72) Inventors: Eliyahu Battat, Petah-Tikva (IL); Michey Mehta, San Jose, CA (US); Robert Krawitz, Chestnut Hill, MA (US); Boaz Ben Shabat, Petah-Tikva (IL); Jenifer Abrams, Colorado Springs, CO (US); Ashish Kamra, Arlington, MA (US)

(21) Appl. No.: 18/185,503

(22) Filed: Mar. 17, 2023

(51) Int. Cl. G06F 9/50; G06F 9/455

(52) U.S. Cl. CPC G06F 9/505; G06F 9/45558; G06F 2009/4557

(57) ABSTRACT

A command identifying a workload for execution within a cluster architecture is received. Responsive to the command, the workload is deployed to a plurality of different runtime engines on one or more compute nodes within the cluster architecture, wherein the plurality of different runtime engines comprise a container-based runtime engine and a virtual machine (VM)-based runtime engine. Performance metrics are received from each of the plurality of different runtime engines corresponding to execution of the workload.

### TECHNICAL FIELD

Aspects of the present disclosure relate to the execution of workloads in orchestrated environments and, more particularly, to determining the performance of a given workload in multiple runtime engines of an orchestrated cluster.

### BACKGROUND

A container orchestration engine (such as the Red Hat™ OpenShift™ module) may be a platform for developing and running applications and may allow applications, and the data centers that support them, to expand from just a few machines and applications to thousands of machines that serve millions of clients. Orchestration engines comprise a control plane and a cluster of compute nodes on which workloads may be scheduled. In some cases, an orchestration engine may manage pods and/or container applications. A pod may refer to the most basic (smallest) compute unit that can be defined, deployed, and managed by the control plane (e.g., one or more containers deployed together on a single host). The control plane may include a scheduler that is responsible for determining placement of new application onto nodes within the cluster. The scheduler may attempt to find a node that is a good fit for the application based on configured policies and predicates.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a schematic block diagram that illustrates an example system, according to some embodiments of the present disclosure.

FIG. 2 is a block diagram that illustrates a workload executing in a plurality of different runtime engines, according to some embodiments of the present disclosure.

FIG. 3 is a block diagram that illustrates an example automated flow of the system, according to some embodiments of the present disclosure.

FIG. 4 is a flow diagram of a method for scheduling a software container, in accordance with some embodiments of the present disclosure

FIG. 5 is a component diagram of an example of a device architecture, in accordance with embodiments of the disclosure.

FIG. 6 is a block diagram that illustrates an example system, according to some embodiments of the present disclosure.

### DETAILED DESCRIPTION

In computer systems supporting development and execution of application services, virtual machines and/or containers may be used. As an example, a virtual machine (“VM”) may be a robust simulation of an actual physical computer system utilizing a hypervisor to allocate physical resources to the virtual machine. As another example, containers are active components executing on an operating system of a host system that provide an environment for applications to run, while being isolated from other components of the host system. Multiple containers may execute on a single operating system kernel and share the resources of the hardware upon which the operating system is running.

Container-based virtualization systems may be lighter weight than systems using virtual machines with hypervisors, while virtual machines may provide more isolation and/or hardware control. Containers may allow widespread, parallel deployment of computing power for specific tasks. For example, a container may be instantiated to process a specific task and terminated after the task is complete. In large scale implementations, container orchestrators (e.g., Kubernetes™) may be used that manage the deployment and scheduling of large numbers of containers across multiple compute nodes. One example of a container orchestration platform is the Red Hat™ OpenShift™ platform built around Kubernetes.

Orchestrator platforms may employ cluster infrastructures. Cluster infrastructures may include a number of workloads providing services (e.g., applications provided using containers and/or VMs, also referred to as the data plane) and a control plane that manages the execution and/or distribution of the workloads on one or more compute nodes. In a cluster infrastructure, the compute nodes, which may include physical hosts, processors on a physical host, or virtual machines, may be configured as resources for execution of the workloads using the containers and/or VMs of the cluster. The orchestrator platform may move the workload between and among the compute nodes as part of managing the execution of the workload. The control plane of the cluster infrastructure may perform the scheduling and/or load balancing of the containers and/or VMs, and their associated workloads, among the compute nodes.

Within a cluster, there are different types of runtime engines that may be used to execute a workload. For example, some workloads may be deployed as containers within the clusters, some workloads may be deployed as VMs, and other workloads may be deployed as VMs within containers, to name only a few examples. Each of the runtime engines may have different advantages and disadvantages, as will be described further herein.

However, each of the runtime engines may also have additional complexities that may need to be managed and/or understood by a system administrator. In may be difficult for a system administrator to get an accurate picture of the performance of a given workload in the different runtime engines. Not only are the configurations for the different runtime engines complex, but they also may utilize different types of workloads, which may make comparisons between the runtime engines difficult. Variations in performance between runtime engines increase the risk for production issues that may be caused due to misconfiguration of the runtime engine. Minor issues can cause a delay in the delivery and/or performance of an application due to slowness or errors, and major issues can cause a redesign of an entire workload implementation, which can be very expensive both in terms of time and resources.

The present disclosure addresses the above-noted and other deficiencies by providing a framework that is configured to execute a common workload across multiple runtime engines. The framework may automatically deploy the workload to a plurality of runtime engines, with attention to the types of configuration used by the given runtime engine. While running on the various runtime engines, metrics may be maintained which are indicative of the performance of the workload on the respective runtime engine.

In some embodiments, the metrics may be made available in an automated dashboard, so that the performance of the workload on the various runtime engines may be compared. In some embodiments, the workload may include one or more benchmarks that may help characterize the configuration of the runtime engine in areas such as processing performance, networking, memory, and/or storage. In some embodiments, the workload may be, or include, a customized workload from a user that may include unique operations that may be compared between runtime engines.

Embodiments of the present disclosure may provide a fully automated containerized framework that can run against a cluster of an orchestration platform (e.g., OpenShift/Kubernetes) by one command line without substantive additional configuration by the user. Embodiments of the present disclosure may simplify the ability to add custom workloads using minimal configuration that identifies the customized elements within a workload. Embodiments of the present disclosure may provide reliable comparisons between different types of runtime configurations that may be useful for determining deployment decisions since each of the different runtime engines may utilize a substantially identical workload. Embodiments of the present disclosure may provide reliable workload scale testing by running the workload against several different nodes at the same time.

Embodiments of the present disclosure may provide a technological solution that reduces a variance in the execution of container workloads by avoiding or minimizing disruptions caused by improper, or inefficient, configuration. By allowing for a performance of the workload to be compared across multiple runtime engines, a performance of the workload within a cluster environment may be improved. In addition, by comparing a given workload across different runtime engines, an amount of resources (e.g., network, memory, processor) may be reduced as compared to inefficient configurations. In addition, by automating the comparison of the workload execution, in some cases concurrently, an amount of computing resources needed to perform such a comparison may be reduced, along with an administrative overhead to perform such a comparison.

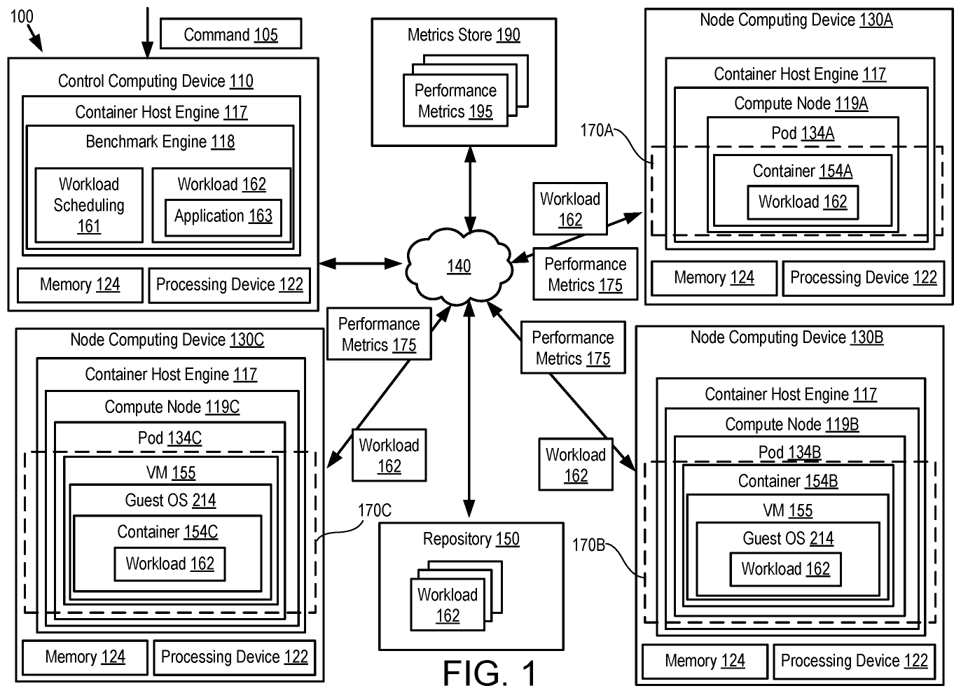

FIG. 1 is a schematic block diagram that illustrates an example system 100, according to some embodiments of the present disclosure. FIG. 1 and the other figures may use like reference numerals to identify like elements. A letter after a reference numeral, such as “130A,” indicates that the text refers specifically to the element having that particular reference numeral. A reference numeral in the text without a following letter, such as “130,” refers to any or all of the elements in the figures bearing that reference numeral.

As illustrated in FIG. 1, the system 100 includes a control computing device 110, and a plurality of node computing devices 130. In some embodiments, system 100 may be a container cluster, though the embodiments of the present disclosure are not limited to such a configuration. In FIG. 1, a first node computing device 130A, a second node computing device 130B, and a third node computing device 130C are illustrated, but the embodiments of the present disclosure are not limited to three node computing devices 130.

The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between the control computing device 110 and the node computing devices 130.

Each computing device 110, 130 may include hardware such as processing device 122 (e.g., processors, central processing units (CPUs), memory 124 (e.g., random access memory 124 (e.g., RAM), storage devices (e.g., hard-disk drive (HDD), solid-state drive (SSD), etc.), and other hardware devices (e.g., sound card, video card, etc.).

Processing device 122 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 122 may also include one or more special-purpose processing devices such as an application specific integrated circuit (ASIC), a field programmable gate array (FPGA), a digital signal processor (DSP), network processor, or the like.

Memory 124 may include volatile memory devices (e.g., random access memory (RAM)), non-volatile memory devices (e.g., flash memory) and/or other types of memory devices. In certain implementations, memory 124 may be non-uniform access (NUMA), such that memory access time depends on the memory location relative to processing device 122. In some embodiments, memory 124 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 124 may be configured for long-term storage of data and may retain data between power on/off cycles of the computing devices 110, 130.

Each computing device 110, 130 may comprise any suitable type of computing device or machine that has a programmable processor including, for example, server computers, desktop computers, laptop computers, tablet computers, smartphones, set-top boxes, etc. In some examples, each of the computing devices 110, 130 may comprise a single machine or may include multiple interconnected machines (e.g., multiple servers configured in a cluster). The computing devices 110, 130 may be implemented by a common entity/organization or may be implemented by different entities/organizations. For example, control computing device 110 may be operated by a first company/corporation and one or more node computing devices 130 may be operated by a second company/corporation.

In some embodiments, the control computing device 110 may implement a control plane (e.g., as part of a container orchestration engine) of a container cluster including the node computing devices 130. The control plane may perform scheduling and/or load-balancing operations on a plurality of pods 134. Further detail on the structure of the pods 134 and the scheduling operations of the control plane will be described herein. In some embodiments, the node computing devices 130 may each implement a compute node 119 (e.g., as part of the container orchestration engine). The compute nodes 119 may execute one of the plurality of pods 134, as will be described further herein.

In some embodiments, a container orchestration engine 117 (also referred to herein as container host engine 117), such as the Red Hat™ OpenShift™ module, may execute on the control computing device 110 and the node computing devices 130. The container host engine 117 may be a platform for developing and running containerized applications and may allow applications and the data centers that support them to expand from just a few machines and applications to thousands of machines that serve millions of clients. Container host engine 117 may provide an image-based deployment module for creating and executing workloads 162.

A workload 162 may be stored by the container host engine 117 or a registry server, such as repository 150. In some embodiments, the workload 162 may contain one or more applications 163. The applications 163 may include computer instructions that perform one or more tasks on the node computing devices 130. For example, the application 163 may be configured to be stored in memory 124 and executed by the processing device 122.

In some embodiments, the workload 162 may be formed and/or stored as an image file. As an example, the workload 162 may be a container image built from a Dockerfile. The workload 162 may contain application code, libraries, tools, dependencies, and/or other files used to make an application 163 run. In some embodiments, the workload 162 may include one or more base layers. Base layers may define the runtime environment as well as the packages and utilities necessary for the application 163 to run. The base layers may include static snapshots of the configuration of the application 163 and may be read-only layers that are not modified during execution of the application 163 and/or workload 162.

An example deployment of the container host engine 117 may include the control plane on one or more control computing devices 110 and a cluster of compute nodes 119, including compute nodes 119A, 119B, 119C on one or more node computing devices 130. The compute nodes 119 may run the aspects of the container host engine 117 that are utilized to launch and manage containers 154, pods 134, VMs 155, and other objects. For example, a compute node 119 may be a physical server that provides the processing capabilities required for running containers 154 and/or VMs 155 in the environment. A compute node 119 may also be implemented as a virtual server, logical container, or GPU, for example.

The basic units that the container host engine 117 may work with are called pods 134. A pod 134 may refer to one or more containers 154 and/or VMs 155 deployed together on a single node computing device 130, and is the smallest compute unit that can be defined, deployed, and managed. There are numerous different scenarios when a new pod 134 may be created. For example, a serverless function may need to scale, and one or more new pods 134 may be created and deployed to additional compute nodes 119 of node computing devices 130 to manage requests for serverless functions provided by containers 154 and/or VMs 155 contained within the pods 134. In FIG. 1, the first node computing device 130A is illustrated executing a first pod 134A, the second node computing device 130B is illustrated executing a second pod 134B, and the third node computing device 130C is illustrated executing a third pod 134C.

Many application instances can be running in containers 154 and/or VMs 155 on a compute node 119 without visibility into other processes, files, network, etc. of other containers 154 and/or VMs 155 of the compute node 119. In some embodiments, each container 154 and/or VM 155 may provide a single function (often called a “micro-service”) or component of the application 163, such as a web server or a database. In this way, the container host engine 117 provides a function-based architecture of smaller, decoupled units that work together.

The control plane of the control computing device 110 may also run a workload scheduling engine 161 that may be responsible for determining placement of (i.e., scheduling) of workloads 162 and/or new pods 134 onto compute nodes 119 within the system 100. For example, a workload 162 may be associated with a pod 134, which may then be scheduled within the system 100. The workload scheduling engine 161 may read data from the workload 162 and/or pod 134 and attempt to find a compute node 119 that is a good fit based on configured policies. Once a suitable compute node 119 is found, the workload scheduling engine 161 may create a binding for the pod 134 that ties the pod 134 to the particular compute node 119. The workload scheduling engine 161 may consider the resource needs of a pod 134 (and/or its associated workload 162), such as processing devices 122 and/or memory 124, along with the health of the system 100, when making scheduling decisions about the pod 134 to an appropriate compute node 119.

In some embodiments of the present disclosure, the workload scheduling engine 161 may be configured to deploy and/or execute a same workload 162 on a plurality of runtime engines 170. As used herein, deploying a workload 162 may include transmitting the workload 162 to a compute node 119 of a node computing device 130 for execution of the workload 162. In some embodiments, deployment of the workload 162 may include communication from the control computing device 110 to the node computing device 130 over network 140 (e.g., using the container host engine 117). As used herein, a runtime engine 170 refers to a configuration of services and/or infrastructure within a pod 134 that may be used to execute an application 163 of a workload 162. Different runtime engines 170 may execute a same workload 162 differently. In FIG. 1, three runtime engines 170 are illustrated, though the embodiments of the present disclosure are not limited to this configuration. In FIG. 1, the first node computing device 130A is illustrated executing a first runtime engine 170A in the first pod 134A, the second node computing device 130B is illustrated executing a second runtime engine 170B in the second pod 134B, and the third node computing device 130C is illustrated executing a third runtime engine 170C in the third pod 134C.

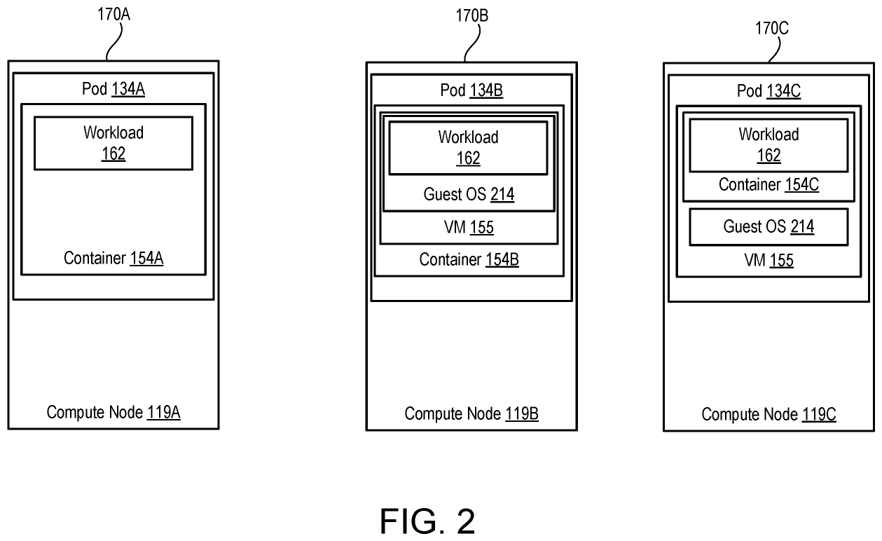

FIG. 2 is a block diagram that illustrates a workload 162 executing in a plurality of different runtime engines 170, according to some embodiments of the present disclosure. FIG. 2 illustrates additional detail of the first runtime engine 170A, the second runtime engine 170B, and the third runtime engine 170C of FIG. 1. A description of elements of FIG. 2 that have been previously described will be omitted for brevity.

Referring to FIGS. 1 and 2, the first runtime engine 170A may be a container-based runtime engine 170A. For example, the first runtime engine 170A may be configured to execute the workload 162 within a pod 134A on a compute node 119A that may include hardware (e.g., processing devices, memory, storage devices, other devices, etc.). A container 154A may execute as part of the compute node 119A (e.g., under control of a host operating system of a node computing device 130A. In one embodiment, the container 154A may be an isolated set of resources allocated to executing the workload 162 and may be process independent from other applications, software, and/or processes of the compute node 119A. The container 154A may also be referred to as a software container 154A. In some embodiments, the compute node 119A may use namespaces to isolate the resources of the containers 154 from each other. The container 154A may share the kernel, libraries, and binaries of the compute node 119A with other containers 154 that are executing on the compute node 119A.

In one embodiment, the runtime engine 170A may allow different containers 154 to share the host OS (e.g., the OS kernel, binaries, libraries, etc.) of the compute node 119A. For example, the runtime engine 170A may multiplex the binaries and/or libraries of the host OS between multiple containers 154. The runtime engine 170A may also facilitate interactions between the container 154A and the resources of the compute node 119A. For example, the runtime engine 170A may manage requests from container 154 to access a memory (e.g., a RAM) of the node computing device 130 of the compute node 119A. In another example, the runtime engine 170A may manage requests from the container 154 to access certain libraries/binaries of the compute node 119A. In other embodiments, the runtime engine 170A may also be used to create, remove, and manage containers 154. In one embodiment, the runtime engine 170A may be a component of the host operating system (e.g., Red Hat™ Enterprise Linux) of the compute node 119A. In some embodiments, the first runtime engine 170A may be based on Kubernetes and/or OpenShift environments.

The second runtime engine 170B may be a runtime engine 170B incorporating a VM 155 in a container 154B. The second runtime engine 170B may also use the container 154B in a manner similar to that of the first runtime engine 170A. However, the second runtime engine 170B may execute a VM 155 including a guest OS 214 within a container 154B, and isolate the workload 162 within the VM 155. In one embodiment, the VM 155 may be a software implementation of a machine (e.g., a software implementation of a computing device) that includes its own operating system (the guest OS 214), including its own kernel, and executes application programs, applications, software. VM 155 may be, for example, a hardware emulation, a full virtualization, a para-virtualization, and an operating system-level virtualization VM 155. For example, the guest OS 214 of the VM 155 may further isolate the workload 162 from other containers 154 and/or processes on the compute node 119B.

As part of executing the container 154B, the compute node 119B may execute the VM with its guest OS 214, which, in turn, executes the workload 162. Thus, the pod 134B may be configured to receive a VM image and/or workload 162, including a configuration for the VM 155, and execute the workload 162 within the pod 134B. The second runtime engine 170B may offer additional isolation for the workload 162 as compared to the first runtime engine 170A. In some embodiments, the second runtime engine 170B may be based on a KUBEVIRT™ implementation. KubeVirt is an open source project for running a VM based Kubernetes deployment which utilizes custom resource definitions (CRD) to create a virtual machine instance (VMI). With the CRD mechanism, Kube Virt can customize additional operations to adjust for behavior that may not be available in a typical container 154.

The third runtime engine 170C may be a runtime engine 170C incorporating a container 154C in a VM 155. In one embodiment, the VM 155 may be a software implementation of a machine (e.g., a software implementation of a computing device) that includes its own operating system (referred to as guest OS 214), including its own kernel, and executes application programs, applications, software. VM 155 may be, for example, a hardware emulation, a full virtualization, a para-virtualization, and an operating system-level virtualization VM 155.

VM 155 may execute guest software that uses an underlying emulation of the physical resources (e.g., virtual processors and guest memory). As illustrated in FIG. 2, the VM 155 of the third runtime engine 170C may include the container 154C that may execute the workload 162. In some embodiments, the compute node 119C may expose resources such as a real or emulated processor(s), real or emulated memory, and/or real or emulated storage of the corresponding node computing device 130 by way of an emulator.

In some embodiments, the pod 134C may be configured to receive a workload 162, including a configuration for the workload 162. The pod 134C may be configured to generate the VM 155, with its associated guest OS 214, and execute the workload 162 within a container 154C within the VM 155. The guest OS 214 may be and/or include a reduced OS kernel and OS infrastructure. This may allow the guest OS 214 to launch more quickly than traditional VMs, while also using fewer system resources. In some embodiments, the third runtime engine 170C may be based on a Kata Container implementation. Kata Containers are an open source project for running a containerized VMs which utilizes a container runtime interface (CRI) to implement a reduced VM to execute a container 154.

FIG. 2 illustrates some of the differences between a container-based first runtime engine 170A, a second runtime engine 170B incorporating a VM in a container, and a third runtime engine 170C incorporating a container in a VM. Each runtime engine 170 offers different benefits, including isolation and speed of instantiation. For example, while the third runtime engine 170C (container in a VM) may offer the most isolation for the workload 162, it may be slower to start and/or require more resources to deploy. The first runtime engine 170A may be lighter weight, but may rely primarily on namespaces to isolate the workload 162 from other aspects of the compute node 119. The second runtime engine 170B may offer improved isolation while remaining relative light weight, but its ultimate performance may depend on the workload 162.

Referring back to FIG. 1, embodiments of the present disclosure may allow for a same workload 162 to be sent to each of the runtime engines 170 so that performance of the runtime engines 170 may be compared against one another. In some embodiments, the execution of the workload 162 on the different runtime engines 170 may be performed concurrently.

For example, in some embodiments, a same workload 162 may be deployed to each of the first runtime engine 170A, the second runtime engine 170B, and the third runtime engine 170C. In some embodiments, the workload 162 may be transmitted to each of the runtime engines by the workload scheduling engine 161 of the control computing device 110. In some embodiments, the workload scheduling engine 161 may modify the workload 162 so as to be compatible for the different runtime engines 170. For example, the workload scheduling engine 161 may include the workload 162 within a container 154A for the first runtime engine 170A, within a container 154B including a VM 155 with a guest OS 214 (see FIG. 2) for the second runtime engine 170, and as part of a VM 155 including a guest OS 214 executing a container 154C (see FIG. 2) for the third runtime engine 170C.

In some embodiments, the workload 162 may be stored in a repository 150 accessible to the network 140. In some embodiments, the workload scheduling engine 161 may be configured to access and retrieve the workload 162 from the repository 150. For example, as part of running the workload 162, the workload scheduling engine 161 may be configured to detect a workload 162 to be run from a provided command 105, and to access the repository 150 dynamically over the network 140 to retrieve the workload 162 for deployment to the runtime engines 170.

In some embodiments, the command 105 may be provided by a user of the system 100, but the embodiments of the present disclosure are not limited to such a configuration. In some embodiments, the command 105 may be an automated command that run periodically, such as every day and/or every week. The command 105 may specify the workload 162 to be executed, one or more of the runtime engines 170 to be utilized for the workload 162, and other configuration options to be used to facilitate the execution of the workload 162, such as authorization credentials.

In some embodiments, the workload 162 may be provided to the workload scheduling engine 161 by a client and/or user of the system 100. For example, a user may provide a customized workload 162 to the workload scheduling engine 161. Providing a customized workload 162 may include providing the workload 162 as an image file (including, e.g., base layers supporting execution of the application 163), along with configuration files that may be used to configure the different runtime engines 170.

For example, a user may first create a workload 162 containing an application 163 to be executed. Creating the workload 162 may include embedding the application 163 into an image file, including supporting libraries and/or configuration infrastructure. In some embodiments, applications like Docker may be used to generate a workload 162 from an instruction script, such as a Dockerfile.

In some embodiments, the user may provide configuration information for each of the first runtime engine 170A, the second runtime engine 170B, and the third runtime engine 170C. For example, for the first runtime engine 170A and the third runtime engine 170C, generating a customized workload 162 may include providing a configuration file. In some embodiments, the configuration file may be based on YAML (YAML Ain′t Markup Language). The configuration file may specify the workload 162 to be utilized and provide additional configuration options that may be utilized to execute the containers 154 of the first and third runtime engines 170A, 170C. For the second runtime engine 170B, generating a customized workload 162 may also include providing a configuration file. In some embodiments, the configuration file may be based on YAML. The configuration file may specify the workload 162 to be utilized and as well as a pointer and/or reference to an image of a VM 155 to be utilized by the second runtime engine 170B to execute the workload 162.

In some embodiments, while executing the workload 162, the runtime engines may provide performance metrics 195 to a metrics store 190. The metric store 190 may be accessible to the network 140, though the embodiments of the present disclosure are not limited to such a configuration. In some embodiments, the performance metrics 195 may be provided to the control computing device 110.

The performance metrics 195 may track performance of the runtime engine 170 and/or the compute node 119 during execution of the workload 162. For example, in some embodiments, the performance metrics 195 may include data related to memory usage, storage usage, processor usage and/or utilization, system latency, interrupts, I/O throughput, and the like. The list of performance metrics 195 is merely an example and is not intended to limit the embodiments of the present disclosure.

In some embodiments, the application 163 of the workload 162 can be, or include, a benchmark application 163. The benchmark application 163 may be configured to stress certain subsystems (e.g., memory, processor, storage) of the compute node 119. In some embodiments, the benchmark application 163 may be configured to emulate a particular type of application, such as a database or web server, to provide performance metrics 195 indicating the performance of a particular runtime engine 170 with respect to that type of application.

In some embodiments, the workload scheduling engine 161 may transmit the workload 162 to the plurality of different runtime engines 170 responsive to a single command 105. (In FIG. 1, a first runtime engine 170A is illustrated on the first node computing device 170A, a second runtime engine 170B is illustrated on the second node computing device 170B, and a third runtime engine 170C is illustrated on the third node computing device 170C. Thus, rather than having to individually configure different images for different runtime engines 170, a single command 105 may generate performance metrics 195 from a number of different runtime engines 170. In some embodiments, the workload scheduling engine 161 may be configured to transmit the workload 162 to the plurality of different runtime engines 170 on a regular basis, such as every night or every week.

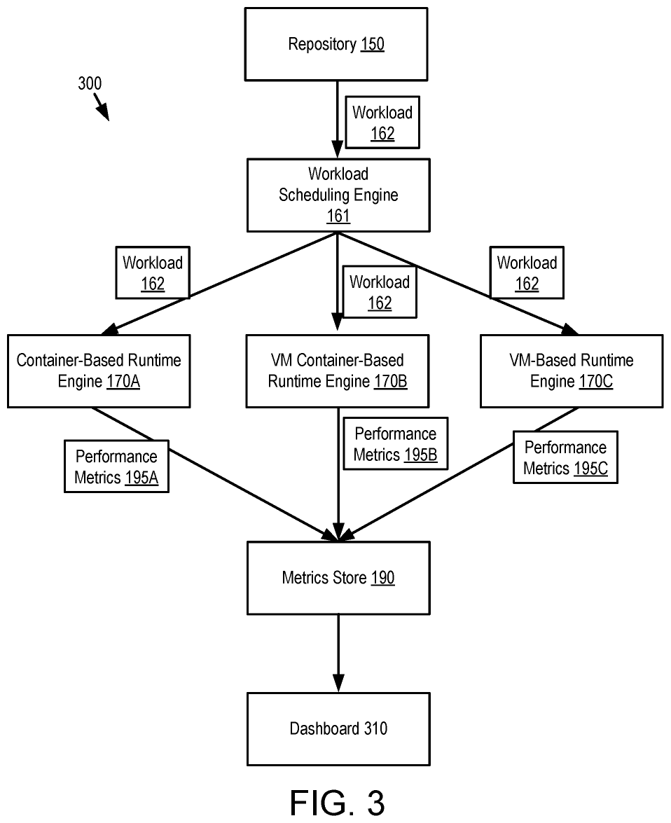

FIG. 3 is a block diagram that illustrates an example automated flow 300 of the system 100, according to some embodiments of the present disclosure. A description of elements of FIG. 3 that have been previously described will be omitted for brevity.

Referring to FIG. 3 as well as the other figures, the automated flow 300 may, in some embodiments, include the workload scheduling engine 161 retrieving the workload 162 from the repository 150. In some embodiments, the workload 162 may be provided directly to the workload scheduling engine 161 (e.g., by a user and/or client). In some embodiments, retrieving the workload 162 may be performed responsive to a command 105 to concurrently execute the workload 162 on a plurality of different runtime engines 170.

The workload scheduling engine 161 may distribute the workload 162 to a plurality of different runtime engines 170. For example, the workload scheduling engine 161 may send the workload 162 to a first container-based runtime engine 170A, to a second runtime engine 170B incorporating a VM 155 in a container 154B, and to a third runtime engine 170C incorporating a container 154C in a VM 155. The first container-based runtime engine 170A, the second runtime engine 170B, and the third runtime engine 170C may be similar to the first, second, and third runtime engines 170A, 170B, 170C described herein with respect to FIGS. 1 and 2. In some embodiments, the workload scheduling engine 161 may prepare the workload 162 in a format compatible with the respective runtime engine 170 to which the workload 162 is being distributed. For example, the workload scheduling engine 161 may include and/or add VM components, such as operating system components, to the workload 162 for compatibility with the second runtime engine 170B incorporating the VM 155 in the container 154B and/or the third runtime engine 170C incorporating the container 154C in the VM 155.

In some embodiments, the first container-based runtime engine 170A, the second runtime engine 170B incorporating the VM 155 in the container 154B, and the third runtime engine 170C incorporating the container 154C in the VM 155 may execute on different compute nodes 119 (see FIG. 1) within the system 100, though the embodiments of the present disclosure are not limited to such a configuration. In some embodiments, the first container-based runtime engine 170A, the second runtime engine 170B incorporating the VM 155 in the container 154B, and the third runtime engine 170C incorporating the container 154C in the VM 155 may execute on a same compute node 119 and/or node computing device 130 (see FIG. 1).

For example, the workload scheduling engine 161 may select the runtime engines 170 to which the workload 162 will be distributed by analyzing available compute nodes 119 of a cluster (e.g., a Kubernetes cluster). In some embodiments, the workload scheduling engine 161 may select runtime engines 170 on different physical node computing devices 130. In some embodiments, the workload scheduling engine 161 may select the different physical node computing devices 130 such that they have similar levels of resources so that performance between the node computing devices 130 can be compared. In some embodiments, the workload scheduling engine 161 may execute each of the runtime engines 170 on a same node computing device 130.

The first container-based runtime engine 170A, the second runtime engine 170B incorporating the VM 155 in the container 154B, and the third runtime engine 170C incorporating the container 154C in the VM 155 may execute the workload 162. In some embodiments, the execution may be performed concurrently, but the embodiments of the present disclosure are not limited to such a configuration. In some embodiments, the execution of the workload 162 may be performed on different ones of the first container-based runtime engine 170A, the second runtime engine 170B incorporating the VM 155 in the container 154B, and the third runtime engine 170C incorporating the container 154C in the VM 155 at different times.

Based on the execution of the workload 162, each of the first container-based runtime engine 170A, the second runtime engine 170B incorporating the VM 155 in the container 154B, and the third runtime engine 170C incorporating the container 154C in the VM 155 may provide performance metrics 195 to the metrics store 190. For example, the first container-based runtime engine 170A may generate first performance metrics 195A while executing the workload 162, the second runtime engine 170B incorporating the VM 155 in the container 154B may generate second performance metrics 195B while executing the workload 162, and the third runtime engine 170C incorporating the container 154C in the VM 155 may generate third performance metrics 195C while executing the workload 162. The performance metrics 195 may indicate an impact of the execution of the workload 162 on the respective runtime engine 170.

In some embodiments, the performance metrics 195 of the metrics store 190 may be used to generate a dashboard 310. The dashboard 310 may provide a user interface, such as a graphical user interface (GUI) that illustrates the performance of the workload 162 on different ones of the runtime engines 170. In some embodiments, the dashboard 310 may include graphs of different elements of the performance metrics 195 compared across different ones of the runtime engines 170. In some embodiments, the dashboard 310 may include a heatmap that identifies areas of high or low performance during the execution of the workload 162.

In some embodiments, the performance metrics 195 and/or the dashboard 310 may be used to compare performance of the workload 162 across the runtime engines 170. Since a same workload 162 is used for each of the runtime engines 170 the comparison may be judging similar characteristics for similar types of operations. Thus, the comparison of the different runtime engines 170 may be comparable, like-for-like, comparison of the performance metrics 195. In some embodiments, the performance metrics 195 and/or the dashboard 310 may be used to select one of the plurality of runtime engines 170 for deployment of the workload 162, or for the deployment of a similar workload within the system 100.

As illustrated in FIG. 3, embodiments of the present disclosure provide a streamlined mechanism for comparing runtime engines 170. The runtime engines 170 can be compared in a real-world environment using embodiments of the present disclosure that generate performance metrics 195 that may show benchmark results for each of the runtime engines 170. The performance metrics 195 may be directly comparable since they are generated by the same workload 162. By using the workload scheduling engine 161 to control the distribution of the workload 162 to different types of runtime engines 170, embodiments of the present disclosure reduce an amount of resources needed to compare runtime engines 170, and provide greater technical accuracy for the comparison of the runtime engines 170, yielding a more accurate comparison and resulting deployment.

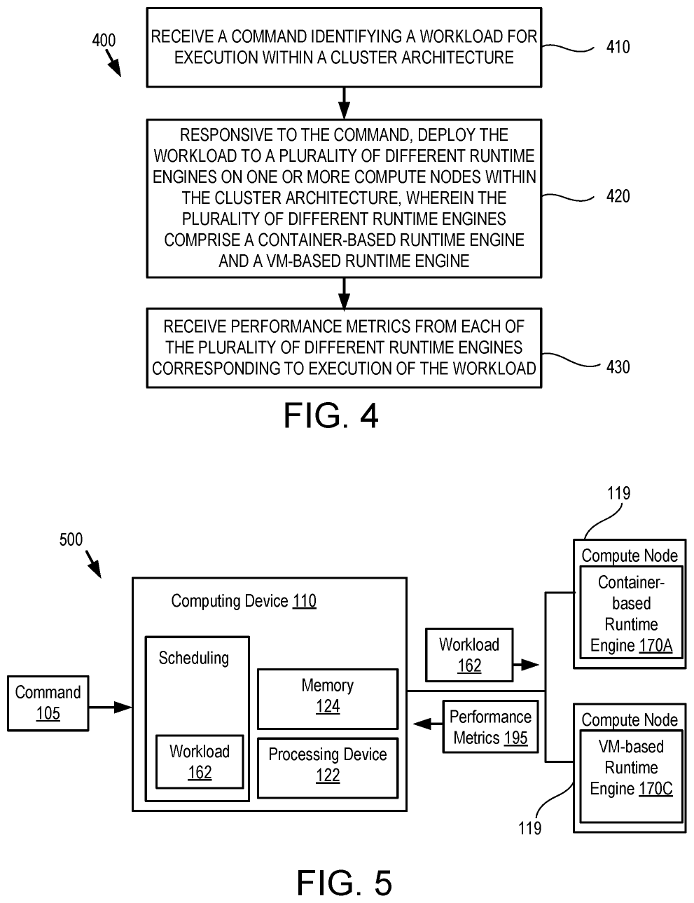

FIG. 4 is a flow diagram of a method 400 for scheduling a software container, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 110 illustrated in FIG. 1).

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring simultaneously to FIGS. 1 to 3 as well, the method 400 begins at block 410, in which a command is received identifying a workload for execution within a cluster architecture. In some embodiments, the workload may correspond to the workload 162 as described herein with respect to FIGS. 1 to 3. In some embodiments, the command may correspond to the command 105 as described herein with respect to FIGS. 1 to 3. In some embodiments, the workload comprises a performance benchmark application.

At block 420, responsive to the command, the workload is deployed to a plurality of different runtime engines on one or more compute nodes within the cluster architecture. The plurality of different runtime engines may include a container-based runtime engine and a VM-based runtime engine. In some embodiments, the plurality of different runtime engines may correspond to the runtime engines 170 described herein with respect to FIGS. 1 to 3. For example, the container-based runtime engine may be similar, at least, to the first and second runtime engines 170A, 170B, and the VM-based runtime engine may be similar, at least, to the second and third runtime engines 170B, 170C, as described herein with respect to FIGS. 1 to 3. In some embodiments, the one or more compute nodes may correspond to the compute nodes 119 described herein with respect to FIGS. 1 to 3. In some embodiments, deploying the workload to the plurality of different runtime engines on the one or more compute nodes within the cluster architecture includes executing the workload on each of the plurality of different runtime engines concurrently.

In some embodiments, the plurality of different runtime engines further include a runtime engine incorporating a VM within a container. For example, the runtime engine incorporating the VM within the container may be similar, at least to the second runtime engine 170B, as described herein with respect to FIGS. 1 to 3. In some embodiments, deploying the workload to the plurality of different runtime engines on the one or more compute nodes within the cluster architecture includes deploying the workload to a respective pod executing on the one or more compute nodes. In some embodiments, the pod may correspond to the pod 134 described herein with respect to FIGS. 1 to 3. In some embodiments, the runtime engine is to execute the workload within a container of the respective pod, the container comprising the VM.

At block 430, performance metrics are received from each of the plurality of different runtime engines corresponding to execution of the workload. In some embodiments, the performance metrics may correspond to the performance metrics 195 described herein with respect to FIGS. 1 to 3.

In some embodiments, the workload is a first workload, and the method 400 further includes deploying a second workload to one of the plurality of different runtime engines based on the performance metrics. In some embodiments, the method 400 further includes generating a heatmap that illustrates a performance of each of the plurality of different runtime engines based on the performance metrics. In some embodiments, the method 400 further includes receiving the workload and a plurality of configuration files corresponding to the workload, wherein the plurality of configuration files indicate configuration options for each of the plurality of different runtime engines.

FIG. 5 is a component diagram of an example of a device architecture 500, in accordance with embodiments of the disclosure. The device architecture 500 includes computing device 110 having processing device 122 and memory 124, as described herein with respect to FIGS. 1 to 4.

The computing device 110 may receive a command 105 identifying a workload 162 for execution within a cluster architecture. The workload 162 may include an application 163, which may be a performance benchmark application in some embodiments, as described herein with respect to FIGS. 1 to 4.

The computing device 110 may, responsive to the command 105, deploy the workload 162 to a plurality of different runtime engines 170A, 170C on one or more compute nodes 119 within the cluster architecture. The plurality of different runtime engines 170A, 170C may include a container-based runtime engine 170A and a VM-based runtime engine 170C. The deployment of the workload 162 may be performed similarly to the operations described herein with respect to FIGS. 1 to 4.

The computing device 110 may receive performance metrics 195 from each of the plurality of different runtime engines 170A, 170C corresponding to execution of the workload 162. In some embodiments, the performance metrics 195 may be used to evaluate the performance of each of the different runtime engines 170A, 170C. In some embodiments, a deployment of subsequent workloads 162 may be adjusted based on the performance metrics 195. For example, responsive to the performance metrics 195, subsequent workloads 162 (e.g., a second workload 162) having an execution profile similar to the workload 162 used to generate the performance metrics 195 may be deployed and/or assigned to one of the different runtime engines 170A, 170C having the best performance, as indicated by the performance metrics 195.

The device architecture 500 of FIG. 5 provides a technological capability to dynamically compare performance of the execution of the workload 162 of different runtime engines 170A, 170C, including runtime engines 170 that include configurations that are implemented through the use of containers 154 and configurations that are implemented through the use of VMs 155. As further described herein, runtime engines, such as runtime engine 170B described with respect to FIGS. 1 to 4, may also be used that combine containers 154 and VMs 155. Embodiments of the present disclosure provide a single scheduling interface that can execute multiple types of runtime engine configurations and collect performance metrics 195 responsive to the execution. Embodiments of the present disclosure allow for the performance of different runtime engines 170 to be compared, while reducing the resources required to make such a comparison.

Embodiments of the present disclosure may provide one framework for cluster deployment, workload execution, and results visualization. Embodiments of the present disclosure may also provide a fully automated containerized framework that can be executed against a cluster by a single command line 105 without requiring a precondition install. Embodiments of the present disclosure may also simplify a way for a user to provide a workload 162 (such as a dockerfile) while other aspects of configuration of the runtime engines 170 are managed for the user. Embodiments of the present disclosure may also provide a reliable comparison of at least three runtime engines 170, while also providing workload scale testing by running the workload 162 against a plurality of compute nodes 119 concurrently.

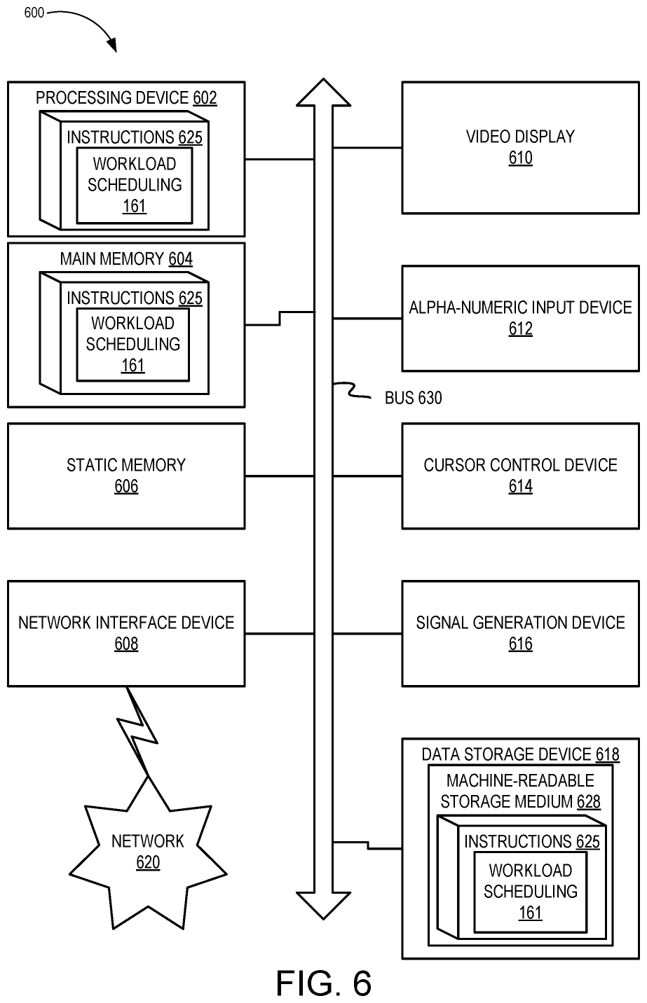

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a component (e.g., workload scheduling engine 161 discussed herein) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “receiving,” “deploying,” “executing,” “generating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a command identifying a workload for execution within a cluster architecture;
responsive to the command, deploying, by a processing device, the workload to a plurality of different runtime engines on one or more compute nodes within the cluster architecture, wherein the plurality of different runtime engines comprise a container-based runtime engine and a virtual machine (VM)-based runtime engine; and
receiving performance metrics from each of the plurality of different runtime engines corresponding to execution of the workload.

2. The method of claim 1, wherein the workload comprises a performance benchmark application.

3. The method of claim 1, wherein deploying the workload to the plurality of different runtime engines on the one or more compute nodes within the cluster architecture comprises executing the workload on each of the plurality of different runtime engines concurrently.

4. The method of claim 1, wherein the plurality of different runtime engines further comprise a runtime engine incorporating a VM within a container,
wherein deploying the workload to the plurality of different runtime engines on the one or more compute nodes within the cluster architecture comprises deploying the workload to a respective pod executing on the one or more compute nodes, and
wherein the runtime engine is to execute the workload within a container of the respective pod, the container comprising the VM.

5. The method of claim 1, wherein the workload is a first workload, the method further comprising deploying a second workload to one of the plurality of different runtime engines based on the performance metrics.

6. The method of claim 1, further comprising generating a heatmap that illustrates a performance of each of the plurality of different runtime engines based on the performance metrics.

7. The method of claim 1, further comprising receiving the workload and a plurality of configuration files corresponding to the workload, wherein the plurality of configuration files indicate configuration options for each of the plurality of different runtime engines.

8. A system comprising:
a memory; and
a processing device, operatively coupled to the memory, to:
receive a command identifying a workload for execution within a cluster architecture;
responsive to the command, deploy the workload to a plurality of different runtime engines on one or more compute nodes within the cluster architecture, wherein the plurality of different runtime engines comprise a container-based runtime engine and a virtual machine (VM)-based runtime engine; and
receive performance metrics from each of the plurality of different runtime engines corresponding to execution of the workload.

9. The system of claim 8, wherein the workload comprises a performance benchmark application.

10. The system of claim 8, wherein, to deploy the workload to the plurality of different runtime engines the one or more compute nodes within the cluster architecture, the processing device is to execute the workload on each of the plurality of different runtime engines concurrently.

11. The system of claim 8, wherein the plurality of different runtime engines further comprise a runtime engine incorporating a VM within a container,
wherein, to deploy the workload to the plurality of different runtime engines on the one or more compute nodes within the cluster architecture, the processing device is to deploy the workload to a respective pod executing on the one or more compute nodes, and
wherein the runtime engine is to execute the workload within a container of the respective pod, the container comprising the VM.

12. The system of claim 8, wherein the workload is a first workload, and
wherein the processing device is further to deploy a second workload to one of the plurality of different runtime engines based on the performance metrics.

13. The system of claim 8, wherein the processing device is further to generate a heatmap that illustrates a performance of each of the plurality of different runtime engines based on the performance metrics.

14. The system of claim 8, wherein the processing device is further to receive the workload and a plurality of configuration files corresponding to the workload, and
wherein the plurality of configuration files indicate configuration options for each of the plurality of different runtime engines.

15. A non-transitory computer-readable storage medium including instructions that, when executed by a processing device, cause the processing device to:
receive a command identifying a workload for execution within a cluster architecture;
responsive to the command, deploy, by the processing device, the workload to a plurality of different runtime engines on one or more compute nodes within the cluster architecture, wherein the plurality of different runtime engines comprise a container-based runtime engine and a virtual machine (VM)-based runtime engine; and
receive performance metrics from each of the plurality of different runtime engines corresponding to execution of the workload.

16. The non-transitory computer-readable storage medium of claim 15, wherein, to deploy the workload to the plurality of different runtime engines the one or more compute nodes within the cluster architecture, the processing device is to execute the workload on each of the plurality of different runtime engines concurrently.

17. The non-transitory computer-readable storage medium of claim 15, wherein the plurality of different runtime engines further comprise a runtime engine incorporating a VM within a container,
wherein, to deploy the workload to the plurality of different runtime engines on the one or more compute nodes within the cluster architecture, the processing device is to deploy the workload to a respective pod executing on the one or more compute nodes, and
wherein the runtime engine is to execute the workload within a container of the respective pod, the container comprising the VM.

18. The non-transitory computer-readable storage medium of claim 15, wherein the workload is a first workload, and
wherein the processing device is further to deploy a second workload to one of the plurality of different runtime engines based on the performance metrics.

19. The non-transitory computer-readable storage medium of claim 15, wherein the processing device is further to generate a heatmap that illustrates a performance of each of the plurality of different runtime engines based on the performance metrics.

20. The non-transitory computer-readable storage medium of claim 15, wherein the processing device is further to receive the workload and a plurality of configuration files corresponding to the workload, and
wherein the plurality of configuration files indicate configuration options for each of the plurality of different runtime engines.
